(19) United States
(12) Patent Application Publication
(10) Pub. No.: US 2024/0212445 A1
(43) Pub. Date: Jun. 27, 2024

(54) GAMING DEVICES, SYSTEMS, AND METHODS FOR TRIGGERING CHANGES TO PAY TABLES

(71) Applicant: IGT, Las Vegas, NV (US)

(72) Inventor: Franz Pierer, Kainbach (AT)

(21) Appl. No.: 18/085,701

(22) Filed: Dec. 21, 2022

(51) Int. Cl. G07F 17/32

(52) U.S. Cl. CPC G07F 17/3244

(57) ABSTRACT

An electronic game machine (EGM) includes a processor and memory comprising instructions that when executed by the processor cause the processor to initiate a gaming session for a grid-based game arranged as an array of cells rendered on a display, render, to the display and in response to receiving player input that initiates a first play of the grid-based game, randomly selected symbols in randomized positions within the array of cells, randomly select, when a wild symbol is rendered to the array of cells for the first play, a nonwild symbol rendered to the array of cells for the first play, increase a pay table of the randomly selected nonwild symbol, determine a payout for the first play using the increased the pay table, and automatically update a credit meter based on the determined payout.

### BACKGROUND

The present disclosure is generally directed to gaming devices, systems, and methods for triggering changes to pay tables, for example, in a grid-based game.

Gaming machines typically offer a number of built-in game play features that contribute to the overall player experience. Any type of game play feature that presents the player with an additional opportunity to win more money or credits is often viewed as desirable and can lead to increased play of the gaming machine.

### BRIEF SUMMARY

In certain embodiments, an electronic game machine (EGM) includes a processor and memory comprising instructions that when executed by the processor cause the processor to initiate a gaming session for a grid-based game arranged as an array of cells rendered on a display, render, to the display and in response to receiving player input that initiates a first play of the grid-based game, randomly selected symbols in randomized positions within the array of cells, randomly select, when a wild symbol is rendered to the array of cells for the first play, a nonwild symbol rendered to the array of cells for the first play, increase a pay table of the randomly selected nonwild symbol, determine a payout for the first play using the increased the pay table, and automatically update a credit meter based on the determined payout.

In certain embodiments, a system comprises a display, a processor, and memory comprising instructions that when executed by the processor cause the processor to initiate a gaming session for a grid-based game arranged as an array of cells rendered on the display, render, to the display and in response to receiving player input that initiates a first play of the grid-based game, randomly selected symbols in randomized positions within the array of cells, randomly select, for each wild symbol rendered to the array of cells for the first play, a corresponding nonwild symbol rendered to the array of cells for the first play, increase a pay table of each randomly selected nonwild symbol by a multiplier, and render, to the display, a visualization of the increased pay table of each randomly selected nonwild symbol.

In certain embodiments, a method comprises initiating a gaming session for a grid-based game arranged as an array of cells rendered on a display, receiving player input that initiates a first play of the grid-based game, rendering, to the display and in response to the player input, randomly selected symbols in randomized positions within the array of cells, randomly selecting, when a wild symbol is rendered to the array of cells for the first play, a nonwild symbol rendered to the array of cells for the first play, increasing a pay table of the randomly selected nonwild symbol by a predefined multiplier, determining a payout for the first play using the increased the pay table, and automatically updating a credit meter based on the determined payout.

Additional features and advantages are described herein and will be apparent from the following Description and the figures.

### BRIEF DESCRIPTION OF THE DRAWINGS

FIG. 1A depicts one example of a computational gaming device for enabling enhanced gaming features related to increasing pay tables of nonwild symbols;

FIG. 1B depicts another example of a computational gaming device for enabling enhanced gaming features related to increasing pay tables of nonwild symbols;

FIG. 2 is a block diagram depicting components of a computational gaming device for enabling enhanced gaming features related to increasing pay tables of nonwild symbols;

FIG. 3 is an illustrative layout of symbols rendered to an array of cells of a grid-based game;

FIG. 4A illustrates a presentation on a display that reflects a state of a grid-based game immediately following a play or spin of the grid-based game;

FIG. 4B illustrates a presentation on the display that reflects a state of the grid-based game shortly after the state shown in FIG. 4A to show a random selection of a nonwild symbol;

FIG. 4C illustrates a presentation on the display that reflects a state of the grid-based game shortly after the state shown in FIG. 4B to show another random selection of a nonwild symbol;

FIG. 4D illustrates a presentation on the display that reflects a state of the grid-based game shortly after the state shown in FIG. 4C to show a final outcome of the play of the grid-based game; and

FIG. 5 is a flow diagram depicting a method of an example process for randomly selecting nonwild symbols and applying corresponding multipliers according to at least one embodiment.

### DETAILED DESCRIPTION

Embodiments of the present disclosure will be described in connection with gaming systems having one or multiple gaming devices that are capable of providing increased pay tables of a symbol in a grid-based game when a certain symbol, such as a wild symbol, lands on a particular play or spin of the grid-based game. The gaming devices may comprise a computational device, such as a slot machine or Electronic Gaming Machine (EGM). While embodiments of the present disclosure will be described in connection with the example of a slot machine, or an EGM implementing wild symbols that increase pay tables of other, nonwild symbols, it should be appreciated that embodiments of the present disclosure are not so limited. For instance, other types of computational devices, such as portable user devices, smartphones, tablets, laptops, Personal Computers (PCs), wearable devices, etc. may be used to implement game features as described herein. Furthermore, it should be appreciated that embodiments of the present disclosure may apply to games other than slot games. For instance, embodiments of the present disclosure may be used in connection with any type of grid-based game such as bingo, keno, slots, matching games, table games, etc.

In at least one embodiment, a gaming device, such as an EGM, randomly selects and increases a pay table of a nonwild symbol present within the array of cells of a grid-based game for that play. This random selection of a nonwild symbol may occur for each wild symbol that lands for a particular play up to a total number of possible nonwild symbols that exist for the grid-based game. The pay table of each randomly selected nonwild symbol may be increased by a same multiplier. In some examples, that multiplier that is selected from a group of predefined multipliers (e.g., randomly selected from a grouping of multipliers ranging from 2× to 10×). In at least one embodiment, each wild symbol that appears in the play may receive a multiplier selected from a group of predefined multipliers (e.g., randomly selected from a grouping of multipliers ranging from 2x to 10×). The payout for the play is determined based on the increased pay tables for selected nonwild symbols and/or the multiplier applied to the wild symbol(s). The system may present a visualization of the increased pay tables and/or the multipliers applied to wild symbols. As may be appreciated, gaming devices operating as described above and below add excitement to the overall game-playing experience, which improves the user experience.

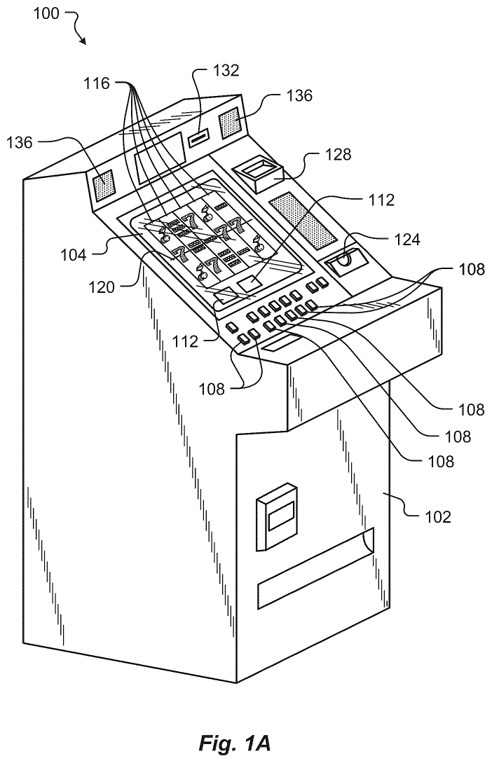

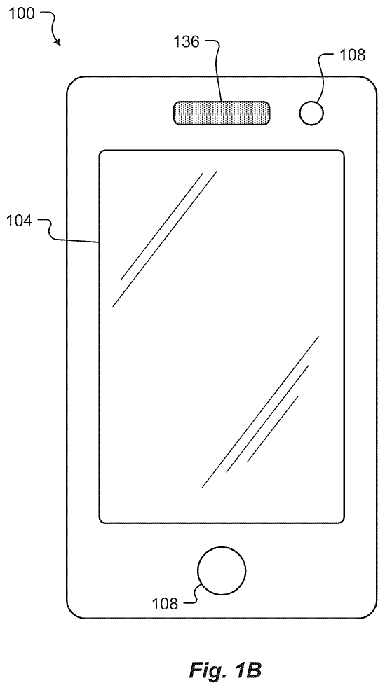

FIGS. 1A and 1B show an illustrative computational device 100 that may be used to implement a grid-based game in accordance with at least some embodiments of the present disclosure. A computational device 100 may include a portable or non-portable device used for executing a gaming application or multiple different gaming applications without departing from the scope of the present disclosure. Non-limiting examples of a computational device include an EGM, a Video Gaming Machine (VGM), a mobile communication device (e.g., a smartphone, laptop, tablet, wearable device, etc.), a personal computer (PC), etc. An EGM or VGM-type of computational device 100 is shown in FIG. 1A in accordance with embodiments of the present disclosure.

The illustrative computational device 100 of FIG. 1A is shown to include a support structure, housing or cabinet, 102 which provides support for a plurality of displays, inputs, controls and other features of a conventional gaming machine. In the illustrated embodiment, a player plays the computational device 100 while sitting, however, the computational device 100 is alternatively configured so that a player can operate it while standing or sitting. The illustrated computational device 100 is positioned on the floor but can be positioned alternatively (i) on a base or stand, (ii) as a pub-style table-top game (e.g., where the participant computational devices are located remotely from the shared wheel as discussed below), (iii) as a stand-alone computational device on the floor of a casino with other stand-alone computational devices, or (iv) in any other suitable manner. The computational device 100 can be constructed with varying cabinet and display configurations.

In one embodiment, a computational device 100 is configured to randomly generate awards and/or other game outcomes based on probability data. Since a computational device 100 generates outcomes randomly or based upon a probability calculation, there is no certainty that the computational device 100 will provide the player with any specific award or other game outcome.

In some embodiments, a computational device 100 may employ a predetermined or finite set or pool of awards, progressive awards, prizes or other game outcomes. As each award or other game outcome is provided to the player, the computational device 100 may remove the provided award or other game outcome from the predetermined set or pool. In some cases, once removed from the set or pool, the specific provided award or other game outcome cannot be provided to the player again. The computational device 100 provides players with all of the available awards or other game outcomes over the course of the play cycle and may guarantee a designated number of actual wins and losses.

The computational device 100 may include one or more displays 112. An illustrative display 112 may include a credit display that displays a player's current number of credits, cash, account balance or the equivalent. Another illustrative display 112 may include a bet display that displays a player's amount wagered.

The computational device 100 is also shown to include at least one payment acceptor. Illustrative payment acceptors may include, without limitation, a coin slot 124, where the player inserts coins or tokens, and a ticket, note, or bill acceptor 128, where the player inserts a bar-coded ticket, note, or cash. In one embodiment, a player-tracking card, credit card, debit card, or data card reader/validator 132 is also provided for accepting any of those or other types of cards as a form of payment toward playing a game on the computational device 100.

In one embodiment, a player inserts an identification card into card reader 132 of computational device 100. The identification card can be a smart card having a programmed microchip or a magnetic strip coded with a player's identification, credit totals, and other relevant information. In one embodiment, money may be transferred to computational device 100 through an electronic fund transfer and card reader 132 using the player's credit, debit, or smart card. When a player funds the computational device 100, a processor of the computational device 100 may determine the amount of funds entered and the corresponding amount is shown on the credit or other suitable display 112 as described above.

In one embodiment, after appropriate funding of computational device 100, the player presses an input device 108 to initiate game play. The input devices 108 may include various types of buttons, levers, gesture inputs, cameras, etc., that enable a player to start any game play or sequence of events. In one embodiment, upon appropriate funding, computational device 100 begins game play automatically. In another embodiment, the player needs to actuate or activate one of the play buttons to initiate play of computational device 100. Other non-limiting types of input devices 108 may include a “bet one” button, a “max bet” button, or any other type of button known to be included in an EGM, VGM, or the like.

It should further be appreciated that the input devices 108 may correspond to a physical button, a virtual button on a touch-screen of a game, an input element on a Graphical User Interface (GUI), or a combination thereof. In other words, the input devices 108 do not need to correspond to a physical button. In some embodiments, the player places a bet by pushing a “bet one” button (e.g., betting an amount equal to one credit for the next play). The player may increase the player's wager by one credit each time the player pushes “bet one” button. When the player pushes the “bet one” button, the number of credits shown in the credit display decreases by one, and the number of credits shown in the bet display increases by one. A “max bet” button can also be provided, which enables the player to bet the maximum wager (e.g., max lines, max wager per line, and re-spin operation). The computational device 100 may include other suitable wager buttons, such as a “repeat bet” button (e.g., repeating the bet made from the immediately previous play of the computational device 100 for the next play of the computational device 100), one or more “select paylines” buttons, a “select re-spin operation” button, and one or more “select wager per payline” buttons.

Another type of input device 108 that may be provided on the computational device 100 is a physical cash out button, a virtual cash out button, a selectable GUI element, or the like. The player presses a cash out button and cashes-out to receive a cash payment or other suitable form of payment corresponding to the number of remaining credits. The player can receive coins or tokens in a coin payout tray or a ticket or credit slip, which are redeemable by a cashier or funded to the player's electronically-recordable identification card.

The computational device 100 may also include one or more display screens 104 and one or more sound generating devices 136. The combination of outputs provided on a display screen 104 and sound generating device 136 may contribute to the game play experience and, in some embodiments, may provide the player with information regarding a status of a game play event or sequence of events.

In one embodiment, the sound generating device 136 may include at least one speaker or other type of transducer for generating audible sounds, playing music, etc. In one embodiment, a computational device 100 provides dynamic sounds coupled with attractive multimedia images displayed on the display screen 104 to provide an audio-visual representation or to otherwise display full-motion video with sound to attract players to the computational device 100. During idle periods, the computational device 100 displays a sequence of audio and/or visual attraction messages to attract potential players to the computational device 100.

In one embodiment, a base or primary grid-based game includes a slot game with one or more paylines 120. As will be discussed in further detail herein, the grid-based game provided by the computational device 100 may support one or multiple paylines 120, which may extend across the display screen 104 vertically, horizontally, diagonally, at adjusted angles, etc. In some embodiments, such as for a slot game, a payline 120 intersects a plurality of reels 116, such as three to five reels. Each reel 116 of the display screen 104 may be used to display different sets of symbols in connection with game play activity provided by the computational device 100. In some embodiments, each reel 116 may operate independent of all other reels and the symbols displayed by a reel 116 at the end of a given spin may depend upon random numbers generated by the computational device 100. The positions of symbols on each reel 116 and in the combination of reels 116 may form an array of cells in a presentation order rendered to the display screen 104 of the computational device 100.

The reels 116 may be provided in video form with simulated reels being displayed via the display screen 104. A reel 116 may be used to display any number of symbols such as bells, hearts, fruits, numbers, letters, bars or other images and symbols, which may correspond to a theme associated with a game provided by the computational device 100. With a slot game, the computational device 100 may be configured to award prizes, awards, or other game play opportunities when the reels 116 stop spinning and a predetermined symbol combination lands across an active payline 120 (e.g., a payline 120 that is currently being wagered and is subject to evaluation for a win after the reels 116 have stopped spinning).

In at least one embodiment, each reel 116 is a mechanical reel that includes one or more mechanisms that mechanically cause each reel 116 to spin.

FIG. 1B illustrates another example of a computational device 100 in accordance with at least some embodiments of the present disclosure. This particular example of computational device 100 may correspond to a portable computational device 100 such as a mobile smartphone, tablet, wearable, etc. The computational device 100 may be owned by a user of the device 100 rather than being owned by a casino operator.

The computational device 100 again includes a display screen 104, a plurality of input devices 108, and at least one speaker 136. In some embodiments, the display screen 104 may correspond to a touch-sensitive display screen, meaning that the display screen 104 is simultaneously capable of displaying information (e.g., in connection with game play activity) and receiving a user input. In some embodiments, the touch-sensitive display screen 104 may provide game features similar to a cabinet-style computational device 100 without requiring all of the dedicated buttons provided by a cabinet-style computational device 100.

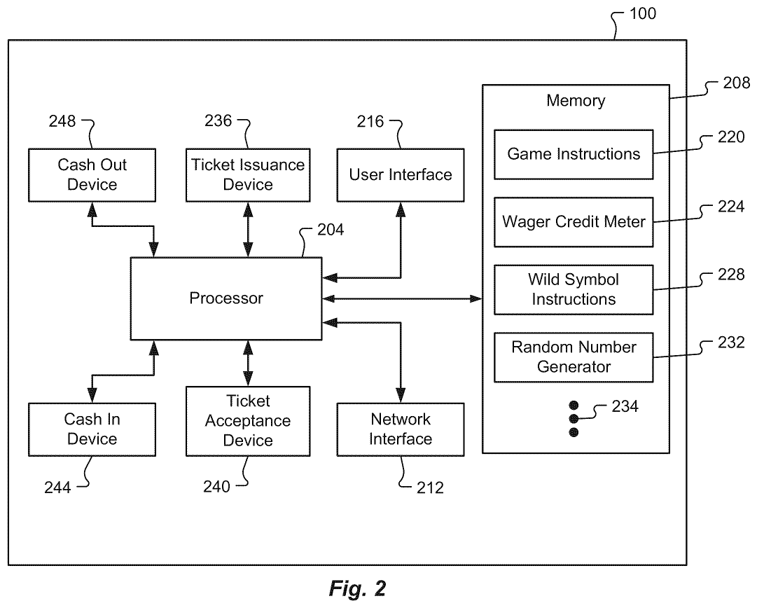

With reference now to FIG. 2, additional details of the components that may be included in a computational device 100 will be described in accordance with at least some embodiments of the present disclosure. The computational device 100 is shown to include a processor 204, memory 208, a network interface 212, and a user interface 216. In some embodiments, the processor 204 may correspond to one or many microprocessors, Central Processing Units (CPUs), microcontrollers, Integrated Circuit (IC) chips, or the like. The processor 204 may be configured to execute one or more instruction sets stored in memory 208. In some embodiments, the instruction sets stored in memory 208, when executed by the processor 204, may enable the computational device 100 to provide game play functionality.

The nature of the network interface 212 may depend upon whether the network interface 212 is provided in cabinet-style computational device 100 or a mobile computational device 100. Examples of a suitable network interface 212 include, without limitation, an Ethernet port, a Universal Serial Bus (USB) port, an RS-232 port, an RS-485 port, a network interface controller (NIC), an antenna, a driver circuit, a modulator/demodulator, etc. The network interface 212 may include one or multiple different network interfaces depending upon whether the computational device 100 is connecting to a single communication network or multiple different types of communication networks. For instance, the computational device 100 may be provided with both a wired network interface 212 and a wireless network interface 212 without departing from the scope of the present disclosure.

The user interface 216 may include a combination of the user input and user outputs described in connection with FIGS. 1A and 1B. For instance, the user interface 216 may include the display screen 104, the input devices 108, the speakers 136, or any other component that is capable of enabling user interaction with the computational device 100. The user interface 216 may also include one or more drivers for the various hardware components that enable user interaction with the computational device 100.

The memory 208 may include one or multiple computer memory devices that are volatile or non-volatile. The memory 208 may be configured to store instruction sets that enable player interaction with the computational device 100 and that enable game play at the computational device 100. Examples of instruction sets that may be stored in the memory 208 include a game instruction set 220, a credit meter 224, and a wild symbol instruction set 228. In addition to the instruction sets, the memory 208 may also include a random number generator 232 that is used by the game instruction set 220, for example, to provide game outputs (e.g., partially random or completely random sequences of symbols). One embodiment of the random number generator 232 includes a pseudo-random number generator.

In some embodiments, the game instruction set 220, when executed by the processor 204, may enable the computational device 100 to facilitate one or more games of chance or skill and produce interactions between the player and the game of chance or skill. In some embodiments, the game instruction set 220 may include subroutines that present one or more graphics to the player via the user interface 216, subroutines that calculate whether a particular wager has resulted in a win or loss during the game of chance or skill, subroutines for determining payouts for the player in the event of a win, subroutines for exchanging communications with another device, such as a server, subroutines for determining random wild symbol appearances during game play, and any other subroutine useful in connection with facilitating game play at the computational device 100.

In some embodiments, the game instruction set 220 may include instructions that initiate a play or a reel spin at the various reels 116 in connection with game play. In some embodiments, the random number generator 232 is used to determine a final position of the reels 116 after the spin is completed. The game instruction set 220 may also be configured to present symbols via the display screen 104 when the reels 116 correspond to video reels or the like. The game instruction set 220 may also be configured to evaluate a position of symbols relative to one or more paylines 120, relative to predetermined symbol areas, or cells in an array of cells, and any other evaluation desired to facilitate game play.

The credit meter 224 may correspond to an instruction set within the computational device 100 that facilitates a tracking of wager activity at the computational device 100. In some embodiments, the credit meter 224 may be used to store or log information related to various player activities and events that occur at the computational device 100. The types of information that may be maintained in the credit meter 224 include, without limitation, player information, available credit information, wager amount information, and other types of information that may or may not need to be recorded for purposes of accounting for wagers placed at the computational device 100 and payouts made for a player during a game of chance or skill played at the computational device 100.

In some embodiments, the credit meter 224 may be configured to track coin in activity, coin out activity, coin drop activity, jackpot paid activity, credits applied activity, external bonus payout activity, voucher in activity, voucher out activity, timing of events that occur at the computational device 100, and the like. In some embodiments, certain portions of the credit meter 224 may be updated in response to outcomes of a game of chance or skill played at the computational device 100. The credit meter 224 may have a corresponding visualization on the user interface 216 to inform the player of a remaining number of credits associated with the player's account.

The wild symbol instruction set 228 may correspond to a subroutine that is called by the game instruction set 220 during game play. In some embodiments, the wild symbol instruction set 228 may be called by the game instruction set 220 when the game instruction set determines that a particular symbol in the array of cells is a wild symbol. In general, a wild symbol or wild may be any symbol that is beneficial to the player. For example, a wild symbol may be a symbol that results in a payout, an increased payout, or other improved game outcome. In at least one example, a wild symbol may be a symbol that “fills in” for any other nonwild symbol in the game to create additional possibilities for winning sequences of symbols. In some examples, a wild symbol refers to a symbol that is used with any other nonwild symbol to create one or more winning combinations of nonwild symbols in a grid-based game. A wild symbol may be replaced with a number of different symbols in a single evaluation of a play of the game to benefit the player or improve the outcome of the game.

In some embodiments, the wild symbol instruction set 228 is configured, when executed by the processor 204, to randomly select, when a wild symbol is rendered to an array of cells of the grid-based game for a play or spin, a nonwild symbol rendered to the array of cells and increase a pay table of the randomly selected nonwild symbol. The pay table of the randomly selected nonwild symbol may be increased by a multiplier (e.g., randomly selected from a predefined set of multipliers). As described herein, a different nonwild symbol may be randomly selected for each wild symbol that appears in the array of cells for the grid based game. For a particular play or spin, each pay table may be increased by the same selected multiplier. However, embodiments are not limited thereto, and in some cases pay tables of randomly selected nonwild symbols may be increased by different multipliers. Notably, once a nonwild symbol has been randomly selected for the play as a result of an appearance of a first wild symbol in that play, that nonwild symbol is removed from the list of possible nonwild symbols that may be randomly selected by virtue of the existence of a second wild symbol in the play. In at least one embodiment, a display 104 of the user interface 216 renders a visualization of the increased pay table for the randomly selected nonwild symbol by, for example, highlighting the increased pay table or providing some other visualization on the display 104 to distinguish the increased pay table from non-increased pay tables of other nonwild symbols. Thereafter, the processor 204 determines a payout for the play using the increased the pay table(s) and automatically updates a credit meter 224 based on the determined payout.

In addition to changing (e.g., increasing) a pay table of a randomly selected nonwild symbol, executing the wild symbol instruction set 228 may further select (e.g., randomly select from a predefined set of multipliers) a multiplier for each wild symbol that appears in a play of the grid-based game. In at least one embodiment, the display 104 of the user interface 216 renders a visualization of the selected multiplier to the display as a substitute for the corresponding wild symbol in the array of cells. For example, the wild symbol may be initially displayed before being replaced by a visual indication of the multiplier selected for the wild symbol. The selected multiplier may be the same or different for each wild symbol that appears in the array of cells. Each multiplier selected for a wild symbol may be applied to the payout for the play. For example, predefined pay lines 120 may exist for the grid-based game, and the multiplier for the wild symbol may be applied to a pay line 120 in which the wild symbol appears. As may be appreciated, the payout for a particular play may be determined based on the increased pay tables of any randomly selected nonwild symbols as well as the multiplier(s) selected for each wild symbol that appeared in the play.

While shown as separate instruction sets, it should be appreciated that the wild symbol instruction set 228 may correspond to part of or as a subroutine of the game instruction set 220 without departing from the scope of the present disclosure. Additional details and functional capabilities of the wild symbol instruction set 228 working in cooperation with the game instruction set 220 will be described in connection with the figures discussed below.

The computational device 100 is further shown to include a ticket issuance device 236, a ticket acceptance device 240, a cash in device 244, and a cash out device 238. The ticket issuance device 236 may be configured to receive physical tickets, vouchers, or player loyalty cards. In some embodiments, the ticket issuance device 236 and ticket acceptance device 240 may operate in concert with the ticket acceptor 128. In such an embodiment, the ticket acceptor 128 may correspond to the physical components that receive and issue a ticket or voucher whereas the ticket issuance device 236 and the ticket acceptance device 240 correspond to the drivers and/or firmware components that control operation of the ticket acceptor 128.

It should also be appreciated that the card reader 132 may be in communication with the ticket issuance device 236 and the ticket acceptance device 140 and may have functionality driven by one or both of these devices. For instance, the card reader 132 may correspond to the physical hardware components that receive information from a player loyalty card (or player loyalty application running on a mobile communication device, etc.) and that information may be processed by the ticket acceptance device 240 when receiving player credits from cards read by the card reader 132. The ticket issuance device 236 may provide the card reader 132 with information for applying wager credits back to a player card when a player is done with a game play session and wishes to transfer credits from the credit meter 224 back onto their card. Thus, the ticket issuance device 236 and ticket acceptance device 240 may also operate as a driver and/or firmware component for the card reader 132.

Similarly, the cash in device 244 and cash out device 248 may include or operate in concert with the coin slot 124 and any coin delivery mechanisms. The cash in device 244 and cash out device 248 may include hardware, drivers, or firmware that facilitate receiving or distributing cash, tokens, bills, etc. In some embodiments, the cash in device 244 may be configured to determine an amount of cash (e.g., in coins, bills, etc.), an amount or number of tokens, etc., input at the coin slot 124 and convert the values into credits for playing games with the game instruction set 220. The cash out device 248 may correspond to hardware and software configured to output coins, tokens, bills, etc. if a player decides to cash out or convert playing credits back into cash, tokens, bills, etc.

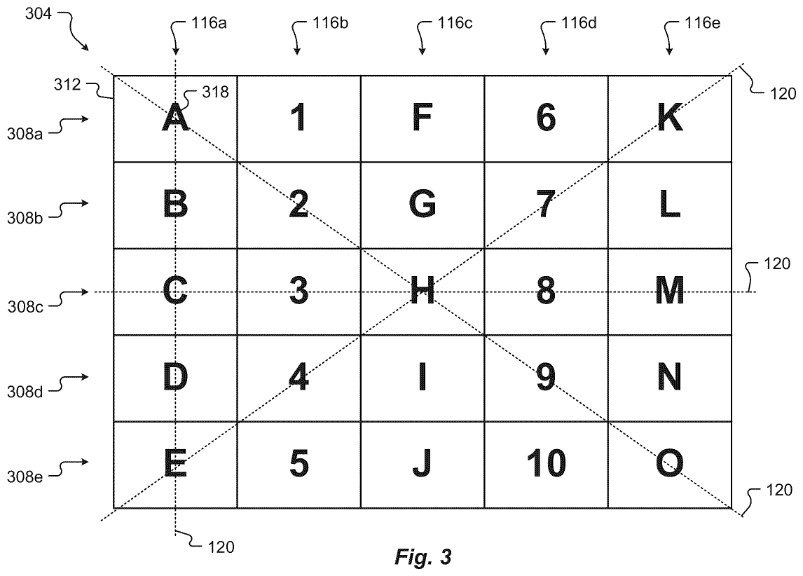

With reference now to FIGS. 3 to 5, various operations of the game instruction set 220 and the wild symbol instruction set 228 will be described in accordance with at least some embodiments of the present disclosure. FIG. 3 illustrates a first layout of symbols 318 rendered to an array of cells 304 of a grid-based game in accordance with embodiments of the present disclosure. The array of cells 304 may be presented, or otherwise rendered, with the display screen 104. In some embodiments, the game instruction set 220 may control which symbols 318 are presented within a particular cell 312 in the array of cells 304. The illustrative array of cells 304 is shown to include five columns 116a, 116b, 116c, 116d, 116e of cells 312 and five rows 308a, 308b, 308c, 308d, 308e of cells 312. Although FIG. 3 illustrates a 5×5 array of cells 304, it should be appreciated that embodiments of the present disclosure can be implemented in an array of cells 304 having a variety of sizes. For instance, embodiments of the present disclosure may be used in an array of cells 304 that are 4×5, 3×3, 3×5, 5×3, 7×3, 10×5, 10×10, etc. The example layout of the array of cells 304 should not be construed as limiting embodiments of the present disclosure.

As can be seen in FIG. 3, each cell 312 in the array of cells 304 may be populated with a single symbol 318. In other words, after the game instruction set 220 has applied the random number generator 232 to determine symbol 318 placement throughout the array of cells 304, there is a 1:1 correlation of symbols 318 to cells 312. Each column 116a, 116b, 116c, 116d, 116e may also be referred to as a reel 116, particularly in the event that the game instruction set 220 provides a slot game. If a slot game is implemented, then the reels 116 (e.g., in video form) are spun (e.g., virtually) and their final position after the spin is determined, at least in part, with assistance of the random number generator 232. In some embodiments, a symbol 318 may correspond to an absence of a symbol or a blank symbol. This blank symbol may correspond to a symbol in a cell 312 having no value.

In some embodiments, payouts or other predetermined game outcomes (e.g., bonus spin opportunities, prize wins, cash wins, re-spin bonus plays, etc.) may be determined based on a symbol combination that falls on a payline 120 that was subject to a wager prior to the spin. In some embodiments, a plurality of the paylines 120 may be selected for “play” prior to a spin, meaning that any payline 120 selected for “play” will be evaluated for a predetermined symbol combination, or sequence of symbols 318. Examples of a sequence of symbols 318 may include, but are in no way limited to, at least one of the sequence [A; 1; F; 6; K] associated with the first row 308a, the sequence [B; 2; G; 7; L] associated with the second row 308b, the sequence [C; 3; H; 8; M] associated with the third row 308c, the sequence [D; 4; I; 9; N] associated with the fourth row 308d, the sequence [E; 5; J; 10; O] associated with the fifth row 308e, and/or reverse sequences of the same.

Additionally or alternatively, the sequence of symbols 318 may include, but are in no way limited to, a sequence of symbols 318 in an order along one or more of the vertical lines of cells 312 associated with the columns 116a-116e (e.g., the sequence [A; B; C; D; E], the sequence [1; 2; 3; 4; 5], etc., and/or reverse sequences of the same). In some embodiments, the sequence of symbols 318 may include, but are in no way limited to, a sequence of symbols 318 in an order along one or more of the cells 312 having a payline 120 running therethrough (e.g., the first diagonal payline sequence [A; 2; H; 9; O], the second diagonal payline sequence [E; 4; H; 7; K], the first vertical payline sequence [A; B; C; D; E], the first horizontal payline sequence [C; 3; H; 8; M], etc., and/or reverse sequences of the same). In one embodiment, the sequence of symbols may comprise all sequences of symbols associated with each row 308a-308e and/or column 116a-116e.

A selected pay line 120 may also correspond to the payline 120 that is evaluated after symbols 318 have been subjected to a wild symbol operation by the wild symbol instruction set 228, which may increase the pay tables of nonwild symbols and/or assign multipliers to any wild symbols. In some embodiments, however, it may be possible to switch or select more paylines 120 for evaluation after a spin has completed, but before a subsequent play operation (e.g., an additional play, a re-spin, etc.) has been performed. The addition of more paylines 120 after the original spin but prior to the subsequent play operation may require the user to provide more credits to the game instruction set 220 as part of enabling evaluation over more paylines 120. Although shown having four different linear paylines 120 (e.g., horizontal, vertical, diagonal, etc.), one or more paylines 120 may be associated with cells 312 in any shape the array of cells 304. In one embodiment, a payline 120 may run through a single row 308a-308e of the array of cells 304 (e.g., first row 308a, etc.). In some embodiments, a pay line 120 may run through one or more columns 116a-116e in the array of cells 304. In any event, embodiments of the present disclosure are not limited to the position and/or shape of the pay lines 120 illustrated herein.

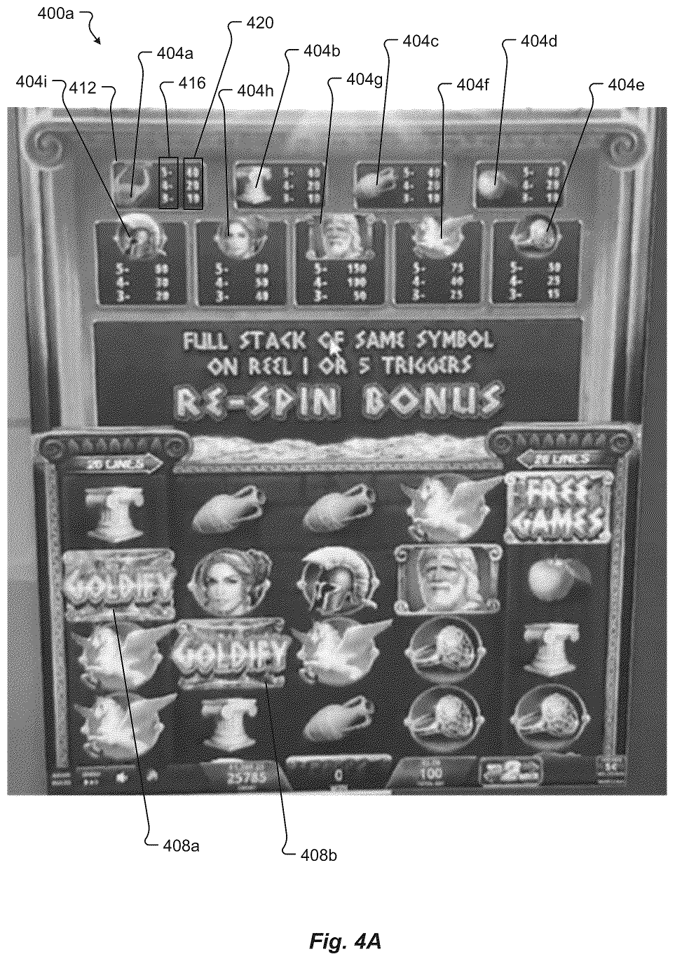

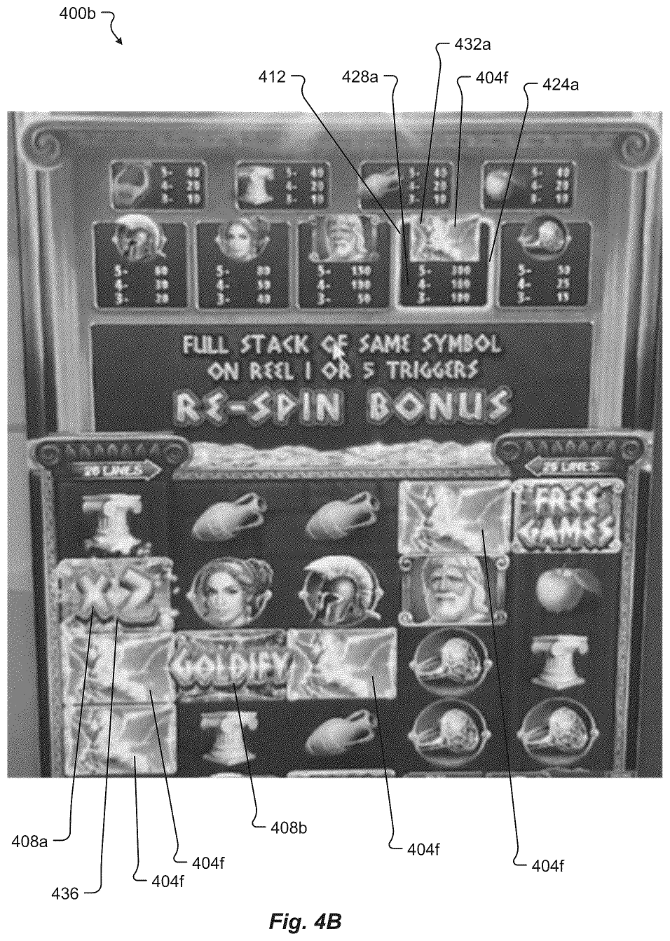

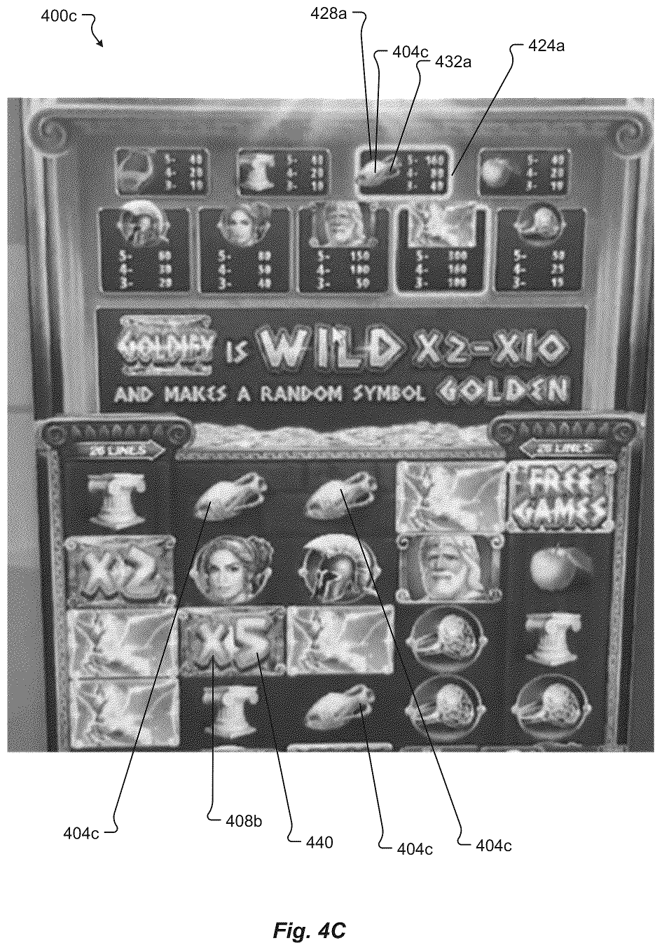

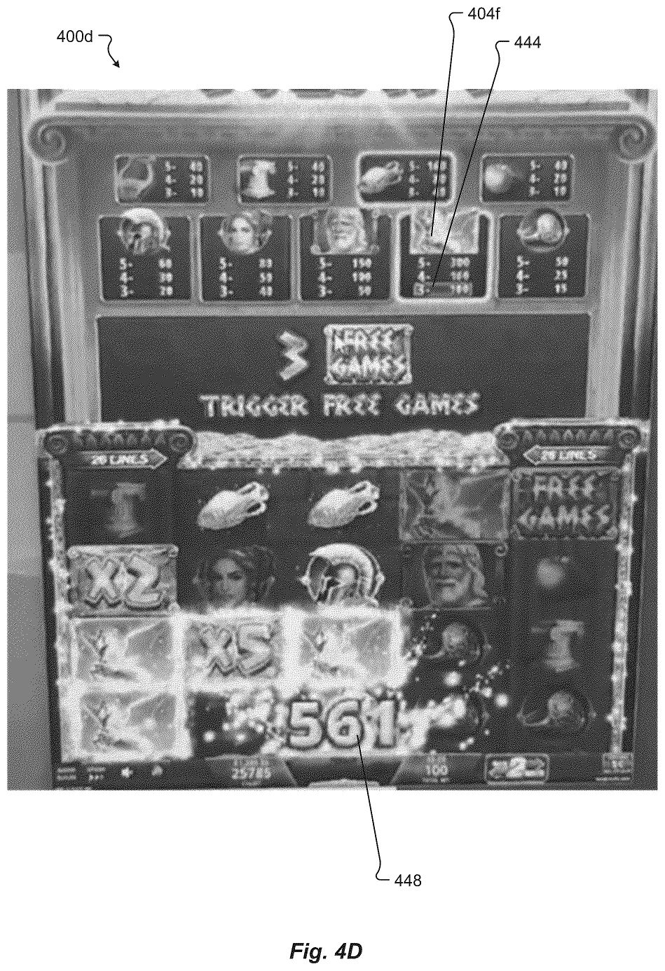

Referring now to FIGS. 4A-4D, an illustrative game play sequence that can be performed by the game instruction set 220 and the wild symbol instruction set 228 will be described in accordance with at least some embodiments of the present disclosure. In some embodiments, FIGS. 4A-4D illustrate various presentations that are caused to be rendered by a display screen 104 of a computational device 100. As may be appreciated, FIGS. 4A to 4D illustrate a specific implementation of a grid-based game with the array of cells 304 discussed above with reference to FIG. 3.

FIG. 4A illustrates a presentation 400a on a display 104 that reflects a state of a grid-based game immediately following a play or spin in which nine possible nonwild symbols 404a to 404i are randomly selected and randomly distributed in a 5×4 array of cells (e.g., based on output of random number generator 232). Presentation 400a illustrates two wild symbols (“Goldify”) 408a and 408b that have landed as part of the sequence of symbols for the play of the grid-based game.

Presentation 400a further illustrates pay tables 412 for each symbol 404a to 404i (only one pay table 412 labeled for symbol 404a for ease of viewing). As may be appreciated, the visualization of pay tables 412 is displayed in a region of the display 104 that is outside of the array of cells. Each pay table 412 initially comprises a visualization 416 with numbers (3, 4, 5) that correspond to the frequency of a symbol 404 that may be present in a pay line 120 (pay lines 120 not explicitly shown in FIGS. 4A to 4D). Each pay table 412 further comprises a visualization 420 of values that correspond to payout amounts associated with each number in visualization 416. Stated another way, visualizations 416 and 420 show how payouts differ depending on how many of a particular symbol appears in a pay line 120. For example, with reference to symbol 404a, the payout for five symbols 404a appearing in pay line is 40 credits, the payout for four symbols 404a appearing in a pay line 120 is 20 credits, and the payout for three symbols 404a appearing in a pay line 120 is 10 credits. Each symbol 404a to 404i may have different associated payouts depending on game design. For example, symbol 404g comprises a pay table 412 that shows a payout of 150 credits for five symbols 404g appearing in a pay line 120, a payout of 130 credits for four symbols appearing 404g appearing in a pay line 120, and a payout of 50 credits for three symbols 404g appearing in a pay line 120.

FIG. 4B illustrates a presentation 400b on the display 104 that reflects a state of the grid-based game shortly after (e.g., one second after) the state shown in presentation 400a to show a random selection of a nonwild symbol. In more detail, presentation 400b illustrates how the appearance of wild symbol 408a causes random selection of nonwild symbol 404f whose pay table 412 is increased by a multiplier, in this case, a multiplier of 4x. Accordingly, each amount in the pay table 412 for nonwild symbol 404f in presentation 400a is shown with visualization 420 in presentation 400b as being increased by a factor of four so that the appearance of five nonwild symbols 404f in a pay line 120 is increased from 75 credits in presentation 400a to 300 credits in presentation 400b, the appearance of four nonwild symbols 404f in a pay line 120 is increased from 40 credits in presentation 400a to 160 credits in presentation 400b, and the appearance of three nonwild symbols 404f in a pay line 120 is increased from 25 credits in presentation 400a to 100 credits in presentation 400b. Although not explicitly shown, it should be appreciated that the increases in each amount on the pay table 412 may be rendered to the display 104 in a rolling or reel fashion that counts upward from each initial amount to the increased amount. Stated another way, presentation 400b may render a visualization of a value in each increased pay table 412 rolling from an original value (e.g., 75) to an increased value (e.g., 300) as dictated by the multiplier. The reel-style count upward may be accompanied by suitable audio.

Presentation 400b further renders at least one visualization to the display 104 to indicate that the pay table 412 for nonwild symbol 404f has been increased compared to the pay tables 412 for other nonwild symbols 404. For example, the pay table 412 of nonwild symbol 404f comprises a highlighted border 424a, a different color background 428a compared to other non-increased pay tables 412, and/or an emphasized graphic 432a. The emphasized graphic 432a may comprise a change in color of the symbol 404f, a change in brightness of symbol 404f, and/or a change to the design of the symbol 404f itself. As shown, the same or similar emphasized graphic 432a in pay table 412 may additionally be rendered for each appearance of symbol 404f in the array of cells.

In addition to increasing the pay table 412 of nonwild symbol 404f and visualizations thereof, a multiplier may be selected and applied to the wild symbol 408a. In this case, the presentation 400b may render a visualization 436 to the display 104 of the selected multiplier as a substitute for the initial wild symbol 408a. In FIG. 4B, the visualization 436 indicates that the multiplier selected for the wild symbol 408a is a 2× multiplier, which may be applied when determining a payout for the play.

As may be appreciated from presentation 400b, the rendering of wild symbol 408b has not changed from its state shown in presentation 400a.

FIG. 4C illustrates a presentation 400c on the display 104 that reflects a state of the grid-based game shortly after (e.g., one second after) the state in presentation 400b to show another random selection of a nonwild symbol 404. In more detail, presentation 400c illustrates a random selection of nonwild symbol 404c due to the appearance of the second wild symbol 408b in presentation 400a. Accordingly, each amount in visualization 420 of the pay table 412 for nonwild symbol 404c in presentation 400a is shown in presentation 400c as being increased by a factor of four so that the appearance of five nonwild symbols 404c in a pay line 120 is increased from 40 credits in presentation 400a to 160 credits in presentation 400c, the appearance of four nonwild symbols 404c in a pay line 120 is increased from 20 credits in presentation 400a to 80 credits in presentation 400c, and the appearance of three nonwild symbols 404c in a pay line 120 is increased from 10 credits in presentation 400a to 40 credits in presentation 400c. Although not explicitly shown, it should be appreciated that the increases in each amount on the pay table 412 may be rendered to the display 104 in a rolling or reel fashion that counts upward from each initial amount to the increased amount. The reel-style count upward may be accompanied by suitable audio.

As in presentation 400b, the pay table 412 of nonwild symbol 404c may comprise one or more visualizations to distinguish over non-increased pay tables. For example, such visualizations may comprise a highlighted border 424b, a different color background 428b compared to other non-increased pay tables 412, and/or an emphasized graphic 432b. The emphasized graphic 432b may comprise a change in color of the symbol 404c, a change in brightness of symbol 404c, and/or a change to the design of the symbol 404c itself. As shown, the same or similar emphasized graphic 432b in pay table 412 may additionally be rendered for each appearance of symbol 404c in the array of cells.

As with wild symbol 408a in presentation 400b, a multiplier may be selected and applied to the wild symbol 408b in presentation 400c. In this case, the presentation 400c may render a visualization 440 to the display 104 of the selected multiplier as a substitute for the initial wild symbol 408b. In FIG. 4C, the visualization 440 indicates that the multiplier selected for the wild symbol 408b is a 5x multiplier, which may be applied when determining a payout for the play.

With reference to FIGS. 4A to 4C, the multiplier applied to a pay table 412 of a randomly selected nonwild symbol 404 may be predefined so that a pay table 412 for a particular symbol 404 is increased by a same multiplier in each play if randomly selected. In some embodiments, however, the multiplier applied to a pay table 412 may be randomly selected from among a set of predefined multipliers for each play (e.g., selected from the group of multipliers 2×, 3×, 4×, 5×, 6×, 7×, 8×, 9×, 10×). In any event, whether randomly selected or predefined, the multiplier applied to a pay table 412 may be the same for each play of the game or may be allowed to change between plays of the game. In some examples, the multiplier is randomly selected or predefined separately for each increased pay table 412. In other examples, the multiplier is randomly selected or predefined for that play and applied to all increased pay tables 412 equally. Although example embodiments have been shown and described as applying the same multiplier to each of the three credit amounts in a pay table 412, different randomly selected or predefined multipliers may be applied to one or more of the credit amounts.

In the same or similar manner as multipliers for pay tables 412, the multiplier applied to each wild symbol 408 may be predefined or randomly selected. FIGS. 4A to 4C illustrate an example where the multiplier assigned or applied to wild symbols 408a and 408b is randomly selected for each wild symbol from a group of possible multipliers (e.g., 2×, 3×, 4×, 5×, 6×, 7×, 8×, 9×, or 10×). However, example embodiments are not limited thereto, and a same randomly selected multiplier or a same predefined multiplier may be applied to all wild symbols 408 in a particular play.

To the extent that predefined or random multipliers are applied to each of the pay tables 412 and the wild symbols 408 for a play of the grid-based game, such multipliers may be reset or redetermined for a next play of the grid-based game.

FIG. 4D illustrates a presentation 400d on the display 104 that reflects a state of the grid-based game shortly after the state shown in presentation 400c to show a final outcome of the play of the grid-based game. In more detail, presentation 400d renders one or more visualizations 444 in pay tables 412 to indicate a winning sequence of symbols that may include nonwild and wild symbols. Here, the visualization 444 comprises a rectangle in the pay table 412 of nonwild symbol 404f highlighting how three symbols 404f have appeared in a pay line 120 at an amount of 100 credits (noting that a wild symbol 408 may be substituted for any nonwild symbol 404). The visualization 444 may be rendered to each pay table 412 for which there exists a winning sequence of that particular symbol 404.

As also shown, presentation 400d includes a visualization 448 showing a number of credits awarded for the play, which may in turn, automatically cause corresponding updates to a credit meter 224. As may be appreciated, credits for the play are awarded for the play as originally presented in presentation 400a by determining a payout as modified by the multipliers applied in presentations 400b and 400c.

As can be appreciated from presentation 400d, the visualizations in presentations 400b and 400c to show application of multipliers to pay tables 412 and to wild symbols 408 are still shown and may continue to be shown until the player initiates a next play of the grid-based game, which causes the visualizations of pay tables 412 and wild symbols to return to their default states, such as those shown in presentation 400a.

Here, it should be further appreciated that the visualizations and multipliers selected and applied during a play or spin of the grid-based game as in presentations 400a to 400d may be rendered to the display 104 automatically as part of the play or spin. Stated another way, the user inputs for a play of the game may include an input to indicate a wager amount prior to the play and an input to initiate the play or spin of the game. Thereafter, presentations 400a to 400d may be automatically rendered to the display 104 and in a predetermined sequence without requiring user input. For example, the processor 204 may automatically assess the sequence of symbols in presentation 400a to identify wild symbols 408 on a column-by-column basis starting with an uppermost symbol in a leftmost column of symbols and moving downward through the column before moving to an uppermost symbol of an immediately adjacent column, and so on for each remaining column. Upon encountering a wild symbol 408 in a column of symbols, the processor 204 renders the visualizations described herein for the encountered wild symbol 408 before moving forward with assessing a remainder of that column and other columns for additional wild symbols 408 and rendering visualizations for the additional wild symbols 408. For example, as shown in FIGS. 4A to 4D, the processor 204 renders presentation 400b, which contains visualizations triggered by the presence of wild symbol 408a, before rendering presentation 400c because the processor 204 encountered wild symbol 408a before encountering wild symbol 408b. In this fashion, the player sees a step-by-step progression of the application of multipliers to the play, which may further enhance the player experience.

In at least one embodiment, the game may prompt the player for input (e.g., to a touch-sensitive area of display 104 or to another input device) to cause progression from rendering the visualizations associated with the presence of a firstly encountered wild symbol 408 to rendering the visualizations associated with the presence of a next encountered wild symbol 408.

In some examples, the player may provide input that causes the processor 204 to skip one or more presentations (e.g., 400b and 400c) to proceed directly to an end presentation showing the outcome of the play or spin (e.g., 400d).

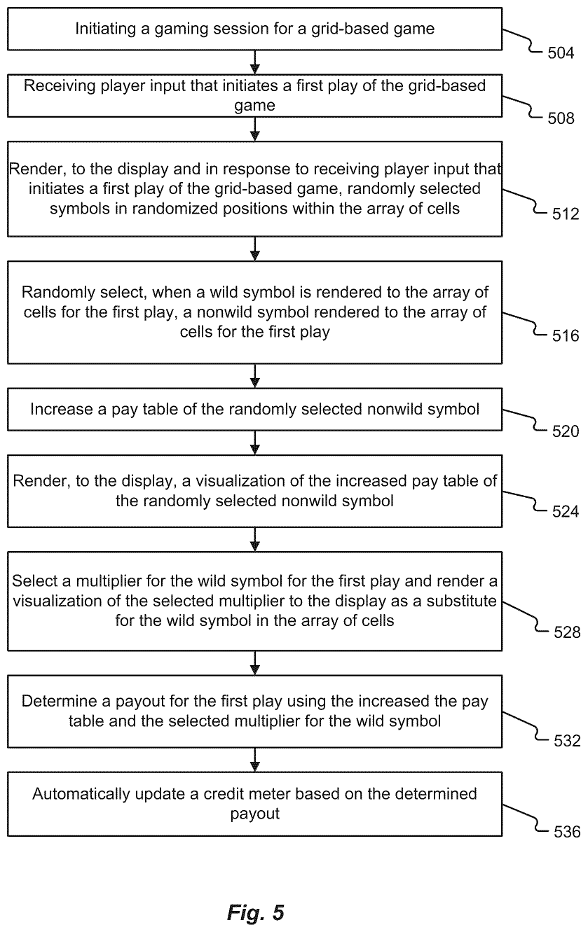

FIG. 5 is a flow diagram depicting a method of an example process for randomly selecting nonwild symbols and applying corresponding multipliers according to at least one embodiment. The methods described herein may be run as a set of instructions on a computational device 100 (e.g., an EGM) and/or some other server in communication with the computational device 100. In some embodiments, the set of instructions may be part of an application installed on the computational device 100. The method in FIG. 5 may correspond to various operations described above with reference to FIGS. 1 to 4D.

Operation 504 includes initiating a gaming session for a grid-based game arranged as an array of cells rendered on a display. Initiating the gaming session may comprise the computational device 100 receiving player input that associates the gaming session with an account of the player so that credits earned or lost during the gaming session are properly reflected by the player's account.

Operation 508 includes receiving player input that initiates a first play of the grid-based game. For example, a computational device 100 may receive player input to an input device 108 to initiate a play of the game as a virtual spin of reels 116 on display 104.

Operation 512 includes rendering, to the display and in response to the player input, randomly selected symbols in randomized positions within the array of cells. Here, it should be appreciated that a presentation, such as presentation 400a may result from the rendering in operation 512. The selection of which symbols to render and in which positions may be determined according to output of the random number generator 232.

Operation 516 includes randomly selecting, when a wild symbol is rendered to the array of cells for the first play, a nonwild symbol rendered to the array of cells for the first play. The random selection of a nonwild symbol may be based on output of the random number generator 232. FIGS. 4A to 4D illustrate examples of wild symbols 408 and nonwild symbols 404 rendered to the array of cells. In the event that the first play does not produce a wild symbol in the array of cells, then the method may proceed directly to determining a payout based on potentially winning sequences of nonwild symbols in the array of cells.

Operation 520 includes increasing a pay table of the randomly selected nonwild symbol by a multiplier. FIGS. 4B and 4C illustrate random selection of nonwild symbols 404f and 404c, respectively, as well as the corresponding increased pay tables 412. As described herein, the increased pay table is increased by a multiplier, which may be randomly selected from among a number of possible multipliers. As shown in FIGS. 4B and 4C, increased pay table comprises multiple values (e.g., amounts) that are increased by the multiplier. As also shown, each value in the multiple values is associated with a different number of possible appearances of the randomly selected nonwild symbol in a pay line of the grid-based game (e.g., the amount of payout is different depending on whether the nonwild symbol appears 3, 4, or 5 times in a pay line 120).

Operation 524 includes rendering, to the display, a visualization of the increased pay table of the randomly selected nonwild symbol. The visualization comprises the increased pay table 412 and non-increased pay tables 412 displayed in a region of the display 104 that is outside of the array of cells. In one embodiment, the visualization rendered in operation 524 distinguishes the increased pay table(s) from non-increased pay tables for a remainder of the first play. Example visualizations 424, 428, and 432 for distinguishing an increased pay table are illustrated in FIGS. 4B to 4D.

Operation 528 includes selecting a multiplier for the wild symbol for the first play and rendering a visualization of the selected multiplier to the display as a substitute for the wild symbol in the array of cells. The visualization in operation 528 is depicted in FIGS. 4B and 4C with visualizations 436 and 440. As noted herein, the multiplier for a wild symbol 408 may be randomly selected from among a number of possible multipliers, and a visualization of the selected multiplier may be rendered to the display 104 as a substitute for the wild symbol 408 in the array of cells (e.g., visualizations 436/440).

Operation 532 includes determining a payout for the first play using the increased the pay table and the selected multiplier for the wild symbol. As noted herein, the payout may be determined based whether a winning sequence of symbols falls within one or more pay lines 120 for the grid-based game, whereupon the increased pay table and multipliers for wild symbols are taken into account when determining the payout.

Operation 536 includes automatically updating a credit meter based on the determined payout. For example, the credit meter 224 is automatically updated to reflect the number of credits gained or lost for the first play. A visualization indicating how many credits were gained or lost for the first play may be displayed on the display (see, e.g., visualization 448 in FIG. 4D).

Here, it should be appreciated that more or fewer operations than those described above may be performed as part of the method in FIG. 5. For example, one or more of the operations in FIG. 5 may be optional. In one embodiment, the method skips operations related to selecting a multiplier for a wild symbol and using the selected multiplier for determining the payout. In this case, the payout does not account for multipliers applied to wild symbols.

It should further be appreciated that operations 516 to 528 in FIG. 5 are carried out for each wild symbol that appears in the first play prior to determining the payout in operation 532.

Although example embodiments have been described with respect to increasing pay tables of nonwild symbols for each existing wild symbol in a play, the pay tables of nonwild symbols may be adjusted in other ways. For example, some wild symbols may cause a decrease to some pay tables while causing a corresponding increase to other pay tables. In some examples, a particular wild symbol decreases the pay table of a nonwild symbol while another wild symbol of a different type increases the pay table of a nonwild symbol.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PUP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. An electronic game machine (EGM), comprising:
a processor; and
memory comprising instructions that when executed by the processor cause the processor to:
initiate a gaming session for a grid-based game arranged as an array of cells rendered on a display;
render, to the display and in response to receiving player input that initiates a first play of the grid-based game, randomly selected symbols in randomized positions within the array of cells;
randomly select, when a wild symbol is rendered to the array of cells for the first play, a nonwild symbol rendered to the array of cells for the first play;
increase a pay table of the randomly selected nonwild symbol;
determine a payout for the first play using the increased the pay table; and
automatically update a credit meter based on the determined payout.

2. The EGM of claim 1, wherein the increased pay table is increased by a multiplier.

3. The EGM of claim 2, wherein the memory comprises instructions that cause the processor to:
randomly select the multiplier from among a number of possible multipliers.

4. The EGM of claim 2, wherein the increased pay table comprises multiple values that are increased by the multiplier.

5. The EGM of claim 4, wherein each value in the multiple values is associated with a different number of possible appearances of the randomly selected nonwild symbol in a pay line of the grid-based game.

6. The EGM of claim 1, wherein the memory comprises instructions that cause the processor to:
determine the payout for the first play further based on pay lines of the grid-based game.

7. The EGM of claim 6, wherein the memory comprises instructions that cause the processor to:
select a multiplier for the wild symbol for the first play; and
determine the payout using the selected multiplier when the wild symbol appears in the pay lines.

8. The EGM of claim 7, wherein the memory comprises instructions that cause the processor to:
randomly select the multiplier from among a number of possible multipliers.

9. The EGM of claim 7, wherein the memory comprises instructions that cause the processor to:
render a visualization of the selected multiplier to the display as a substitute for the wild symbol in the array of cells.

10. The EGM of claim 1, wherein the memory comprises instructions that cause the processor to:
render a visualization of the increased pay table to the display.

11. A system, comprising:
a display;
a processor; and
memory comprising instructions that when executed by the processor cause the processor to:
initiate a gaming session for a grid-based game arranged as an array of cells rendered on the display;
render, to the display and in response to receiving player input that initiates a first play of the grid-based game, randomly selected symbols in randomized positions within the array of cells;
randomly select, for each wild symbol rendered to the array of cells for the first play, a corresponding nonwild symbol rendered to the array of cells for the first play;
increase a pay table of each randomly selected nonwild symbol by a multiplier; and
render, to the display, a visualization of the increased pay table of each randomly selected nonwild symbol.

12. The system of claim 11, wherein the visualization comprises the increased pay table of each randomly selected nonwild symbol displayed in a region of the display that is outside of the array of cells.

13. The system of claim 12, wherein the visualization comprises a value in each increased pay table rolling from an original value to an increased value as dictated by the multiplier.

14. The system of claim 13, wherein the visualization distinguishes each increased pay table from non-increased pay tables.

15. The system of claim 11, wherein the instructions comprise instructions that cause the processor to:
determine a payout for the first play using the increased the pay table of each randomly selected nonwild symbol; and
automatically update a credit meter based on the determined payout.

16. A method, comprising:
initiating a gaming session for a grid-based game arranged as an array of cells rendered on a display;
receiving player input that initiates a first play of the grid-based game;
rendering, to the display and in response to the player input, randomly selected symbols in randomized positions within the array of cells;
randomly selecting, when a wild symbol is rendered to the array of cells for the first play, a nonwild symbol rendered to the array of cells for the first play;
increasing a pay table of the randomly selected nonwild symbol by a predefined multiplier;
determining a payout for the first play using the increased the pay table; and
automatically updating a credit meter based on the determined payout.

17. The method of claim 16, further comprising:
rendering, to the display, a visualization of the increased pay table.

18. The method of claim 17, wherein the visualization comprises the increased pay table displayed in a region of the display that is outside of the array of cells.

19. The method of claim 17, wherein the visualization comprises a value in the increased pay table rolling from an original value to an increased value as dictated by the predefined multiplier.

20. The method of claim 17, wherein the visualization distinguishes the increased pay table from non-increased pay tables for a remainder of the first play.
